(19) United States
(12) Patent Application Publication
(10) Pub. No.: US 2022/0019618 A1
(43) Pub. Date: Jan. 20, 2022

(54) AUTOMATICALLY CONVERTING AND STORING OF INPUT AUDIO STREAM INTO AN INDEXED COLLECTION OF RHYTHMIC NODAL STRUCTURE, USING THE SAME FORMAT FOR MATCHING AND EFFECTIVE RETRIEVAL

(71) Applicant: Pavan Kumar Dronamraju, Sanford, FL (US)

(72) Inventor: Pavan Kumar Dronamraju, Sanford, FL (US)

(21) Appl. No.: 16/929,104

(22) Filed: Jul. 15, 2020

(51) Int. Cl. G06F 16/632; G06F 16/683; G06F 16/955; G10L 15/26

(52) U.S. Cl. CPC G06F 16/634; G10L 15/26; G06F 16/955; G06F 16/685

(57) ABSTRACT

The present invention relates to a method of representing wave oscillations uniquely into machine readable data structure, and search technique using Symphonic quality of audio content as compared to lexicality of the audio content. An automatic computer processing acoustic search method for converting an input audio encoding of an utterance into an output that rhythmically harmonizes with a target song is disclosed.

### TECHNICAL FIELD OF THE INVENTION

The present invention relates to a method of representing wave oscillations uniquely into machine readable data structure, and search technique using Symphonic quality of audio content as compared to prevailing lexical match.

### BACKGROUND OF THE INVENTION

Every Audio content in this universe comprises of basic sound notes that are commonly described in Indian Classical music using an octet of notes. Each sound note has a specific normalized frequency. Such a sequence of notes ascending and descending in frequency, form wave like oscillations, giving the audio content a unique recognition. Every such unique oscillation identified from the input audio source is then represented as a objective value equivalent using special hashing algorithm that consider below node attributes as input to the algorithm:
Normalized Frequency of each note in the oscillation.
Specific order of sound frequencies in the oscillation.
Length of individual sound frequency in the oscillation.
Overall length of the oscillation altogether.

A user trying to search for a long-forgotten song on internet is a humongous task today. One must remember the words from the song to search for the content. The best streaming content providers such as YouTube have not enabled a melody-based search on their apps to this date. Current search uses voice recognition to convert spoken words into text and uses this text indirectly to search existing content in their content database. There is also a set of other applications that use the Acoustic fingerprinting technique such as “Shazam”, where a random pattern of the input audio voice is converted into a fingerprint. The fingerprint is created by considering a primary peak point in the spectrogram and a secondary anchor point as a key into the hash table. Content that matches with this key are stored within the hash table related to the key. Though this seems to be a good procedure, yet not an efficient method to store and retrieve Audio content. The main limitation being identification of most promising secondary anchor point in the wave, which may not be present in the input audio string used for search, failing to match effectively against the Acoustic thumbprint.

### SUMMARY OF THE INVENTION

The present invention relates generally to computer processing techniques that include digital signal processing for automatic processing of speech (speech), and more particularly, a system or device that encodes input speech (audio) of speech (speech), songs with beat or rhythm for playing (an audible provided) (song), wrap, or self relates programmed can techniques to dynamic converted into output encoding other representation modes.

According to an aspect of the present invention, an automatic computer processing acoustic search method for converting an input audio encoding of an utterance into an output that rhythmically harmonizes with a target song is disclosed.

According to one aspect of the present invention, each audio source represented as a set of repeating wave oscillations of sound frequency, referred to as an “Acoustic Node” going forward, is uniquely identified by a composite collection of 4 distinct node attributes, which is then stored in a repository called “Acoustic Node Map” along with related original source locator (URL). This store is created as a list of hash map objects, where hash key is represented by the tinyurl of the original audio source, and hash value is represented by a collection of multiple unique “Acoustic Nodes” associated with the audio source.

Each such Acoustic node in the “Acoustic NodeMap” is indexed using below Node attributes for faster access in that specific order:
Node's Frequency sequence string
Node's Value equivalence
Node's length
Tinyurl geo location (original Source locale)

Audio source represented as a hashmap is now ready to be used for search logic, where client applications can send a small sound wave, for example: a user humming a song that produces a known wave pattern somewhat equivalent to the original content, noticeably without any lyrical words, as an input audio search stream.

This proposed invention uses a much effective version of creating a more reliable storage structure that slices the Audio source into regular rhythmic cycles representing one full wave oscillation in the spectrogram. In other words, one full peak and a trough on the spectrogram. This wave is recognized as a combination of notes (sequence of frequencies raising and dropping) and their corresponding wavelength. Introduced hereby, is the name “Acoustic Node” that refers to “Frequency sequence string”, “length of each frequency in the oscillation” and the “overall wavelength” attributes, converted into machine codes that then can be converted into a unique node equivalence value represented as a binary or hexadecimal equivalent. These unique Acoustic nodes evaluated as a node value equivalence, as stated in the abstract section above, gives unique and strong resemblance matching ability when searched using above-mentioned Node attributes.

The present invention provides a method that considers a composite of attributes to create unique Acoustic node structure and uses these attributes to index “Acoustic Node map” thus organized.

According to one aspect of the invention, a computer processing method is implemented to convert an input speech (audio) encoding of an utterance (utterance) to an output that rhythmically harmonizes with a target song (target song). Is done. The method (i) divides the input speech encoding of a utterance into a plurality of segments, the segments corresponding to a continuous sequence of speech encodings, and a start (start bounded by rising), and this, the method comprising: mapping the individual segments of the plurality of segments into sub phrase part of a phrase template for (ii) the target song, mapping one-one establishes the above phrase candidates, and this (iii) and rhythm skeletons for target song, and thereby at least one time aligned among phrase candidates, of (iv) input speech encoding Corresponding to temporally aligned phrase candidates mapped from the segment delimited by the start, Includes providing a voice encoding of speech occurring as a result.

According to one aspect of the invention, the method further includes audio encoding of the backing track for the subject song, mixing the resulting audio encoding, and playing the mixed audio. In some embodiments, the method includes capturing speech uttered by the user (eg, from a microphone input of a portable handheld device) as input speech encoding, and at least one of a phrase template and a rhythm skeleton. Searching for a computer readable encoding (eg, in response to the user selecting a target song). In some cases, searching in response to a user selection includes obtaining at least a phrase template from a remote storage device via a communication interface of the portable handheld device.

According to one aspect of the invention, the method further includes retrieving a computer readable encoding of the timbre sequence. In some cases, the searching is in response to a user selection in the user interface of the portable handheld device, and from the remote storage device via the communication interface of the portable handheld device, at least a phrase template for the target song and get the timbre sequence.

According to one aspect of the invention, the method is performed on a portable computing device selected from the group of a compute pad, personal digital assistant or book reader and a mobile phone or media player. In some embodiments, the method is performed utilizing a special purpose, toy or amusement device. In some embodiments, a computer program product encodes instructions executable on a processor of a portable computing device to cause the portable computing device to perform the method in one or more media. In some cases, the one or more media can be read by a portable computing device or read by a computer program product that is transmitted to the portable computing device.

According to one aspect of the invention, an apparatus on a portable computing device to convert the input speech encoding of speech to a portable computing device and an output that rhythmically matches the subject song. Machine-readable code embodied in an executable and non-transitory medium, the machine-readable code including instructions executable to divide the input speech encoding of the speech into a plurality of segments Corresponds to a continuous sequence of samples of speech encoding and is delimited by the start identified therein. The machine readable code is further executable to map individual segments of the plurality of segments to each subphrase portion of the phrase template for the target song, wherein the mapping is one or more phrase candidates. The machine readable code is further executable to temporally align the rhythm skeleton for the subject song and at least one of the phrase candidates. The machine readable code is further executable to prepare a speech encoding of the resulting utterance corresponding to the temporally aligned phrase candidates mapped from the segment delimited by the start of the input speech encoding. In some cases, the device is embodied as one or more of a compute pad, a handheld mobile device, a mobile phone, a personal digital assistant, a smartphone, a media player, and a book reader.

According to one aspect of the invention, the computer program product is executable to convert the input speech encoding of speech to an output encoded in a non-transitory medium and rhythmically harmonized with the subject song. Includes instructions. The computer program product includes instructions executable to divide an input speech encoding of a speech into a plurality of segments, the segments being samples of speech encoding delimited by a start identified therein Corresponds to a continuous sequence of The computer program product further includes instructions that are executable to map individual segments of the plurality of segments to each sub-phrase portion of the phrase template for the subject song. Establish one or more phrase candidates. The computer program product further includes encoded rhythm skeletons for the subject song and instructions executable to temporally align at least one phrase candidate. The computer program product can be implemented to prepare a speech encoding of the resulting utterance in response to temporally aligned phrase candidates mapped from segments delimited by the start of input speech encoding. Includes further encoded instructions. In some cases, the media can be read by a portable computing device or can be read associated with a computer program product that is transmitted to the portable computing device.

According to one aspect of the invention, the method further includes audio encoding of the backing track for the subject song, mixing the resulting audio encoding, and playing the mixed audio. In some embodiments, the method further includes capturing speech uttered by the user (eg, from a microphone input of a portable handheld device) as input speech encoding. In some embodiments, the method further includes searching for a computer readable encoding of at least one of the rhythm skeleton and backing track for the target song (eg, in response to selection of the target song by the user). In some cases, searching in response to user selection may obtain either or both of a rhythm skeleton and/or backing track from a remote storage device via a portable handheld device communication interface.

According to one aspect of the invention, the tinyurl stored in “Acoustic Node Map” referring to an external source link associated in a one-many relationship with the actual “Acoustic Nodes”. Clearly the present invention is based on symphonic sound quality and not on lexical equivalent of audio content. The method of searching Audio content is more efficient and the method of search is referred to as “Acoustic Search”.

Additional advantages of the present invention will become readily apparent from the following discussion, particularly when taken together with the accompanying drawings.

### BRIEF DESCRIPTION OF THE DRAWINGS

Other objects and advantages of the present invention will become apparent to those skilled in the art upon reading the following detailed description of the preferred embodiments, in conjunction with the accompanying drawings, wherein like reference numerals have been used to designate like elements, and wherein:

FIG. 1 illustrates schematic representation of the architecture according to one embodiment of the invention; and

FIG. 2 illustrates schematic representation of the layout according to one embodiment of the invention.

The drawings described herein are for illustration purposes only and are not intended to limit the scope of the present invention in any way.

### DETAILED DESCRIPTION OF THE INVENTION

It is to be understood that the present disclosure is not limited in its application to the details of composition set forth in the following description. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced items.

Each statement of an embodiment is to be considered independent of any other statement of an embodiment despite any use of similar or identical language characterizing each embodiment. The wording “one embodiment”, or the like, does not appear at the beginning of every sentence in the specification, is merely a convenience for the reader's clarity. However, it is the intention of this application to incorporate by reference the phrasing “an embodiment,” and the like, at the beginning of every sentence herein where logically possible and appropriate.

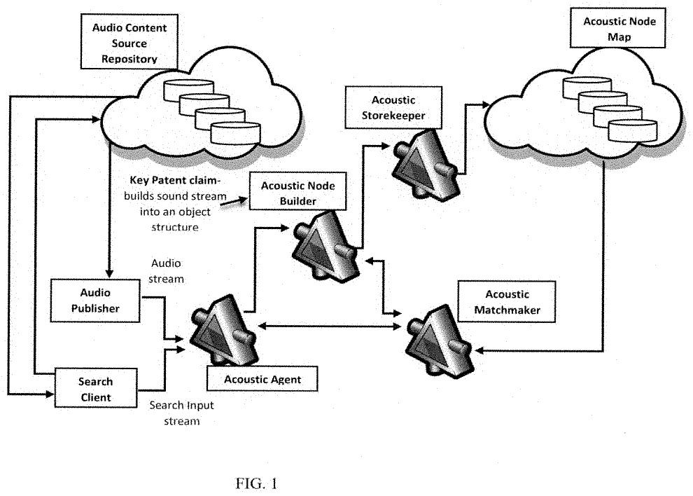

FIG. 1 illustrates schematic representation of the architecture according to one embodiment of the invention. As shown in FIG. 1, an acoustic agent, an acoustic match maker, an acoustic node builder, and an acoustic storekeeper are included in the schematic representation. The schematic representation also includes audio content source repository.

According to one embodiment of the invention, the present invention discloses a search for audio song by melody as an input. No words or lexical equivalent input required for searching for Audio content on internet.

According to one embodiment of the invention, the present invention discloses a method to convert audio Wave oscillation as an “Acoustic Node”. “Acoustic Node” is a special representation.

According to one embodiment of the invention, the present invention discloses a method to generate Node Value equivalence using an algorithm that takes Node attributes as inputs assigning a value to each oscillation.

According to one embodiment of the invention, the only link between the repository of the present invention and content source owner who stores the information with the repository of the present invention is the url link. The url link is stored into the repository.

According to one embodiment of the invention, whenever there is match of the audio content of the content searcher with the content publisher, the url link is returned to the content searcher.

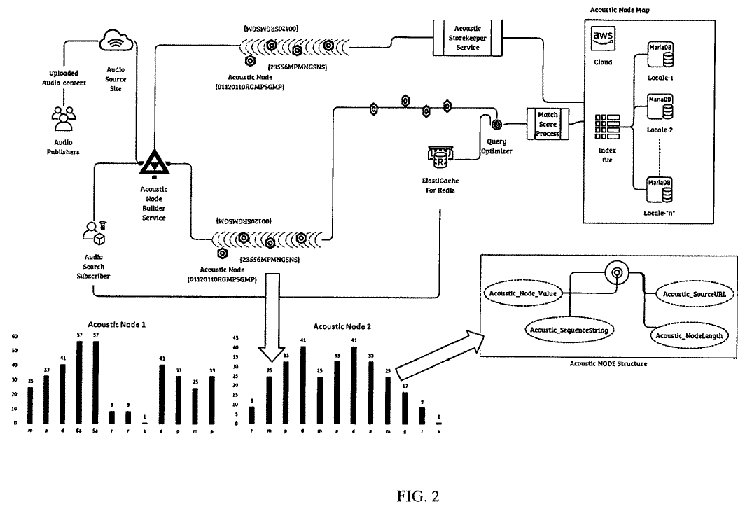

FIG. 2 illustrates schematic representation of the layout according to one embodiment of the invention. The schematic representation of the layout includes an acoustic node map. As shown in FIG. 2, there are the information passes in two ways. In a first way, the information passes from audio publishers. In a second way, the information passes from the audio search subscriber.

According to one embodiment of the invention, one or more audio publishers upload the information on an audio source site, for example on a cloud server. The audio publisher uses the acoustic node service of the present invention to convert the audio content into a set of nodes, referred to as acoustic nodes. For example, in an audio song, the musical notes repeat for several times in the particular song. The entire musical note is converted into a node structure.

According to one embodiment of the invention, unique nodes within the audio song are captured and stored in the repository of the present invention. All the acoustic nodes are collected and are called as acoustic node collection. The acoustic node collection is mapped to an attribute called as “tinyurl”. The “tinyurl” of the present invention is a url to the original audio file uploaded by the audio publisher.

According to one embodiment of the invention, the audio file is an Indian song. In general an Indian song comprises 8 musical nodes. Any sound produced will be mapped with one of the 8 musical nodes. A song may have nodes repeated at various intervals of the song. However, only one unique musical node of the audio song is stored in the repository.

According to one embodiment of the invention, the sequence of the musical node and length of the complete wave of the musical node is stored as an attribute of that particular musical node.

According to one embodiment of the invention, the content owner of the audio files uses the search method of the present invention and converts the audio files into acoustic nodes. The acoustic nodes converted are saved on the repository system of the present invention. The repository system includes a link to the original audio file uploaded.

According to one embodiment of the invention, the audio search subscriber who wants to retrieve an audio file inputs the same musical structure of the original file by humming or with the help of any musical instrument. The input provided by the audio search subscriber is consider by the same node builder service to convert the tune of the audio search subscriber into the musical node structure. If there is a complete match between the audio file input with anyone of the musical node stored in the repository of the present invention, a tinyurl of the original audio file is provided to the audio search subscriber.

According to one embodiment of the invention, one or more tinyurl(s) is/are provided to the audio search subscriber even when there is reasonable amount of match of the audio file input with the musical node stored in the repository.

According to one embodiment of the invention, the audio stream converted into the “Acoustic Node” structure proposed by this invention, can then be sent to matching engine that returns the tinyurl's depending on relevant matching score. A matching score here would be the percentage conformance in Node equivalence value between input search string and various nodes indexed in the “Acoustic Node Map” associated with their respective tinyurls.

The table provided below provides a use case with detailed steps according to an embodiment of the invention

| | Scenario | |
|---|---|---|
| Persona(s) | Description | Use Case - Steps |
| CONTENT_PUBLISHER | Content Owner converts | 1. Owner Registers with Acoustic Search service |
| CONTENT_PRODUCER | original content into | 2. Owner provides source content as audio file |
| CONTENT_OWNER | Acoustic Node list and | 3. Wave patterns are identified within the audio |
| | stores into Acoustic | 4. Each unique wave is converted into Acoustic Node having |
| | Node Map. | below node attributes. |
| | | a. Acoustic node Value |
| | | b. Note Sequence String |
| | | c. Node length |
| | | d. Node Recurrence count |
| | | e. Custom Attributes (for future enhancements) |
| | | 5. These Acoustic nodes along with the content's “source |
| | | URL” are stored as a HashMap object in the Acoustic |
| | | Node Map. |
| CONTENT_SUBSCRIBER | Search content is | 1. Client registers with Acoustic Search service |
| CONTENT_SEARCH_CLIENT | converted into Acoustic | 2. Client submits search content as an audio file along with |
| | Node list and searched | expected matching percentage. |
| | within Acoustic Node | 3. Wave patterns are identified within submitted audio |
| | Map to return matching | 4. Each wave is converted into Acoustic nodes having |
| | source URL's | attributes as shown in above scenario. |
| | redirecting client to the | 5. This node list is sent to matching. |
| | original content. | 6. Match logic searches within “Acoustic Node Map” and |
| | | returns content Source URLs matching with submitted |
| | | search audio, having match score better than requested |
| | | percentage. |
| | | 7. Client navigates to the returned URLs and downloads |
| | | audio content from the original producer. |

According to one embodiment of the invention, the present invention discloses a Search content which is converted into Acoustic Node list and searched within Acoustic Node Map to return matching source URL's redirecting client to the original content.

According to one embodiment of the invention, the present invention discloses a system in which a content publisher or content producer or content owners converts the original content into Acoustic Node list and stores into the Acoustic nodes along with the content's “source URL” and the “source URL” are stored as a HashMap object in the Acoustic Node Map.

According to one embodiment of the invention, the present invention discloses a system in which a content publisher or content producer or content owners Registers with Acoustic Search service can provides source content as audio file and the Wave patterns are identified within the audio file, Each unique wave is converted into Acoustic Node having below node attributes.
a. Acoustic node Value
b. Note Sequence String
c. Node length
d. Node Recurrence count
e. Custom Attributes (for future enhancements)

These Acoustic nodes along with the content's “source URL” are stored as a HashMap object in the Acoustic Node Map.

According to one embodiment of the invention, the present invention discloses a system in which a content subscriber or content search client can search the original contents within Acoustic Node list and Acoustic Node Map via matching source URL's which redirecting client to the original content.

According to one embodiment of the invention, the present invention discloses a system in which a content subscriber or content search client registers with Acoustic Search service can easily submits search content as an audio file along with expected matching percentage the wave patterns are identified within submitted audio and the each wave is converted into Acoustic nodes having attributes as shown in above scenario this node list is sent to matching and the Match logic searches within “Acoustic Node Map” and returns content Source URLs matching with submitted search audio, having match score better than requested percentage and the Client navigates to the returned URLs and downloads audio content from the original producer.

According to one embodiment of the invention, the present invention discloses use of effective indexing on Node Attributes and tinyurl properties such as source content locale for faster search.

According to one embodiment of the invention, the present invention identifies matching audio patterns more effectively and accurately. The present invention adds value in music industry and entertainment software as well as forensic and defense departments, to identify matching audio patterns more effectively and accurately.

According to one embodiment of the invention, the present invention can also be used to store and match the sounds produced in nature such as seismographs, cosmic vibrations, Meteorological audio recordings with higher accuracy and build Machine learning intelligence on top to predict the actual input samples to the historical events stored in the database generating useful observations.

It should be noted that in some embodiments, the user may select and reselect from a library of phrase templates for different target songs, performances, performers, styles, etc.

According to one embodiment of the invention, the fundamental frequency or pitch of a speech changes continuously, but generally does not sound like a musical melody. Typically, the change is too small, fast or infrequent to sound like a musical melody. Pitch changes occur for a variety of reasons, including sound generation methods and speaker emotional states, and indicate phrase endings or questions and unique parts of the tone language.

According to one embodiment of the invention, speech encoding of speech segments) is pitch corrected according to a timbre sequence or melody score.

According to one embodiment of the invention, a desirable attribute of the implemented speech-melody (S2M) transformation is that the speech sounds clearly like a musical melody but remains clearly understandable.

According to one embodiment of the invention, a rhythm pattern is defined, generated, or searched. It should be noted that in some embodiments, the user may select and reselect from a library of rhythm skeletons for different target raps, performances, performers, styles, etc. In some embodiments, the rhythm pattern is represented as a series of impulses at a particular time position.

According to one embodiment of the invention, more complex patterns of audio inputs can also be defined. Some embodiments in accordance with the present invention (s) can be executed one after the other in a computer system (such as an iPhone handheld, mobile device or portable computing device) to implement the methods described herein. In the form of a computer program product encoded in a machine-readable medium as a sequence of software instructions and other functional configurations tangibly embodied in a temporary medium and/or provided as a computer program product

Although the invention (s) has been described in connection with various embodiments, these embodiments are illustrative and the scope of the invention is limited thereto. Many variations, modifications, additions and improvements are possible.

It will be recognized that the above described subject matter may be embodied in other specific forms without departing from the spirit or essential characteristics of the disclosure.

1. An automatic computer processing acoustic search method for converting an input audio encoding of an utterance into an output that rhythmically harmonizes with a target song.

2. The automatic computer processing acoustic search method as claimed in claim 1, wherein the acoustic search method comprises a system in which content publisher or content producer or content owner can convert original content into Acoustic Node list and stores into Acoustic Node Map.

3. The automatic computer processing acoustic search method as claimed in claim 1, wherein the acoustic search method comprises a system in which content subscriber or content search client can search content which is converted into Acoustic Node list and searched within Acoustic Node Map to return matching source URL's redirecting client to the original content.

4. The automatic computer processing acoustic search method as claimed in claim 1, wherein the acoustic search method comprises acoustic nodes along with the content's “source URL” is stored as a HashMap object in the Acoustic Node Map.

5. The automatic computer processing acoustic search method claimed in claim 1, wherein the acoustic search method comprises a much effective version of creating a more reliable storage structure that slices the Audio source into regular rhythmic cycles representing one full wave oscillation in the spectrogram.

6. The automatic computer processing acoustic search method as claimed in claim 1, wherein a content search client can search the target song by melody as an input for searching for Audio content on internet.

7. The automatic computer processing acoustic search method as claimed in claim 1, wherein the wherein the acoustic search method converts the audio Wave oscillation as an “Acoustic Node”, which is a special representation of the node.

8. The automatic computer processing acoustic search method as claimed in claim 1, wherein the wherein the acoustic search method generates a Node Value equivalence using an algorithm that takes Node attributes as inputs assigning a value to each oscillation.

9. The automatic computer processing acoustic search method as claimed in claim 1, wherein the acoustic search method uses the effective indexing on Node Attributes and tinyurl properties such as source content locale for faster search.
